(19) United States
(12) Patent Application Publication
(10) Pub. No.: US 2015/0159722 A1
(43) Pub. Date: Jun. 11, 2015

(54) TORSIONAL KEYED SLEEVE FLUID DAMPER

(71) Applicant: GM GLOBAL TECHNOLOGY OPERATIONS LLC, Detroit, MI (US)

(72) Inventors: Mark A. Stebbins, Bloomfield Hills, MI (US); Rene Dianne Kreis, Flat Rock, MI (US); Joseph A. Schudt, Macomb, MI (US)

(73) Assignee: GM GLOBAL TECHNOLOGY OPERATIONS LLC, Detroit, MI (US)

(21) Appl. No.: 14/097,305

(22) Filed: Dec. 5, 2013

(51) Int. Cl. F16F 9/14

(52) U.S. Cl. CPC F16F 9/145

(57) ABSTRACT

A damper assembly for a rotating shaft includes an inner sleeve and an outer sleeve extending along a longitudinal axis. The outer sleeve is disposed radially outward of the inner sleeve relative to the longitudinal axis. The inner sleeve is rotatable relative to the outer sleeve about the longitudinal axis. A damping fluid is disposed between the inner sleeve and the outer sleeve. At least one of the inner sleeve and the outer sleeve includes a damping feature, such as a fin, vein, channel, etc., which engages the damping fluid. The engagement between the damping feature and the damping fluid resists rotation of the inner sleeve relative to the outer sleeve to attenuate torsional vibration disturbances transmitted to the inner sleeve.

### TECHNICAL FIELD

The invention generally relates to a fluid damper assembly for a rotating shaft.

### BACKGROUND

Torsional vibration of a rotating shaft is angular vibration along the axis of rotation of the rotating shaft. Torsional vibration is a concern in power transmission systems that use rotating shafts. For example, engine and/or transmission operation may generate torsional vibration, which may be transmitted in a prop shaft of a vehicle. Rotating shafts subject to torsional vibration often include a damper assembly for attenuating the torsional vibration.

### SUMMARY

A damper assembly for a rotating shaft is provided. The damper assembly includes an inner sleeve that extends along a longitudinal axis. An outer sleeve extends along the longitudinal axis, and is disposed radially outward of the inner sleeve relative to the longitudinal axis. The inner sleeve is rotatable relative to the outer sleeve about the longitudinal axis. A damping fluid is disposed between the inner sleeve and the outer sleeve. At least one of the inner sleeve and the outer sleeve includes a damping feature, which engages the damping fluid. The engagement between the damping feature and the damping fluid resists rotation of the inner sleeve relative to the outer sleeve to attenuate torsional vibration disturbances transmitted to the inner sleeve.

A fluid damper is also provided. The fluid damper includes an inner sleeve and an outer sleeve. The inner sleeve extends along a longitudinal axis, and is configured for attachment to and rotation with a rotating shaft. At least one inner fin is attached to the inner sleeve. The at least one inner fin extends radially outward from the inner sleeve, relative to the longitudinal axis. The outer sleeve extends along the longitudinal axis, and is disposed radially outward of the inner sleeve relative to the longitudinal axis, i.e., the outer sleeve is disposed around the inner sleeve. The inner sleeve is rotatable relative to the outer sleeve about the longitudinal axis. At least one outer fin is attached to the outer sleeve. The at least one outer fin extends radially inward from the outer sleeve, relative to the longitudinal axis. A damping fluid is disposed between the inner sleeve and the outer sleeve. The at least one inner fin and the at least one outer fin each engage the damping fluid to resist rotation of the inner sleeve relative to the outer sleeve, and to attenuate torsional vibration disturbances transmitted to the inner sleeve from the rotating shaft.

Accordingly, the inner sleeve of the fluid damper assembly is attached to the rotating shaft so that the fluid damper assembly may dissipate torsional vibration in the rotating shaft. The damping features, e.g., the inner fins and the outer fins, engage the damping fluid, e.g., silicone, as the inner sleeve rotates with the rotating shaft relative to the outer sleeve. Rotation of the inner sleeve relative to the outer sleeve causes the inner fins to move relative to the outer fins, which causes the damping fluid to move between and around the inner fins and the outer fins. The mass of the fluid damper assembly, along with the fluidic movement of the damping fluid between and around the damping features, absorb the energy of the torsional vibration, converting the absorbed energy into heat, which is effectively dissipated by the damping fluid.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a fluid damping assembly attached to a rotating shaft.

FIG. 2 is a schematic cross sectional view of the fluid damping assembly showing a plurality of inner fins.

FIG. 3 is a schematic cross sectional view of the fluid damping assembly showing a plurality of inner fins and a plurality of outer fins.

FIG. 4 is a schematic cross sectional view of the fluid damping assembly taken along a longitudinal axis of the rotating shaft.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

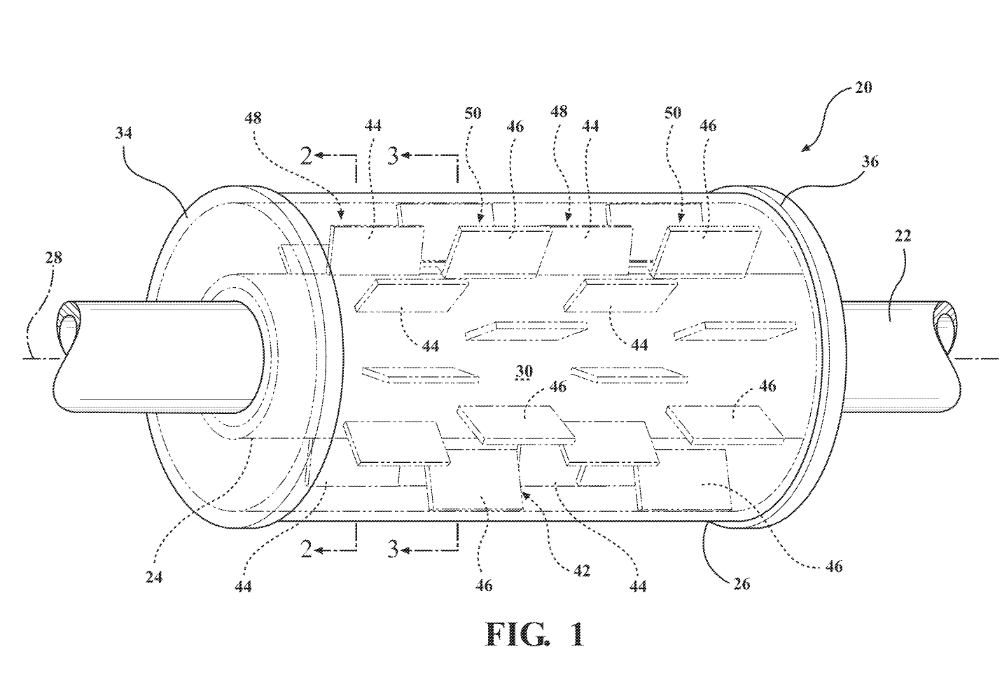

Referring to the Figures, wherein like numerals indicate like parts throughout the several views, a fluid damper assembly is generally shown at 20. Referring to FIG. 1, the fluid damper assembly 20 is attached to a rotating shaft 22, such as but not limited to a prop shaft of a vehicle. The fluid damper assembly 20 reduces torsional vibration in the rotating shaft 22.

Referring to FIGS. 1 through 4, the damper assembly 20 includes an inner sleeve 24 and an outer sleeve 26, which each extend along a longitudinal axis 28. The inner sleeve 24 is disposed radially within the outer sleeve 26. Accordingly, the outer sleeve 26 is disposed radially outward of the inner sleeve 24 relative to the longitudinal axis 28. The outer sleeve 26 is radially spaced from the inner sleeve 24 to define an interior region 30 therebetween. The inner sleeve 24 and the outer sleeve 26 are concentric with each other and are concentrically located about the longitudinal axis 28. The inner sleeve 24 is configured for attachment to the rotating shaft 22. The inner sleeve 24 may be attached to the rotating shaft 22 in any suitable manner, such as but not limited to a press fit connection, in which the inner sleeve 24 is press fit over and onto the rotating shaft 22. When attached to the rotating shaft 22, the inner sleeve 24 rotates with the rotating shaft 22 about the longitudinal axis 28. The inner sleeve 24 is rotatable relative to the outer sleeve 26 about the longitudinal axis 28. Preferably, the inner sleeve 24 includes and is manufactured from a metal, such as but not limited to aluminum. Similarly, the outer sleeve 26 includes and is manufactured from a metal, such as but not limited to aluminum.

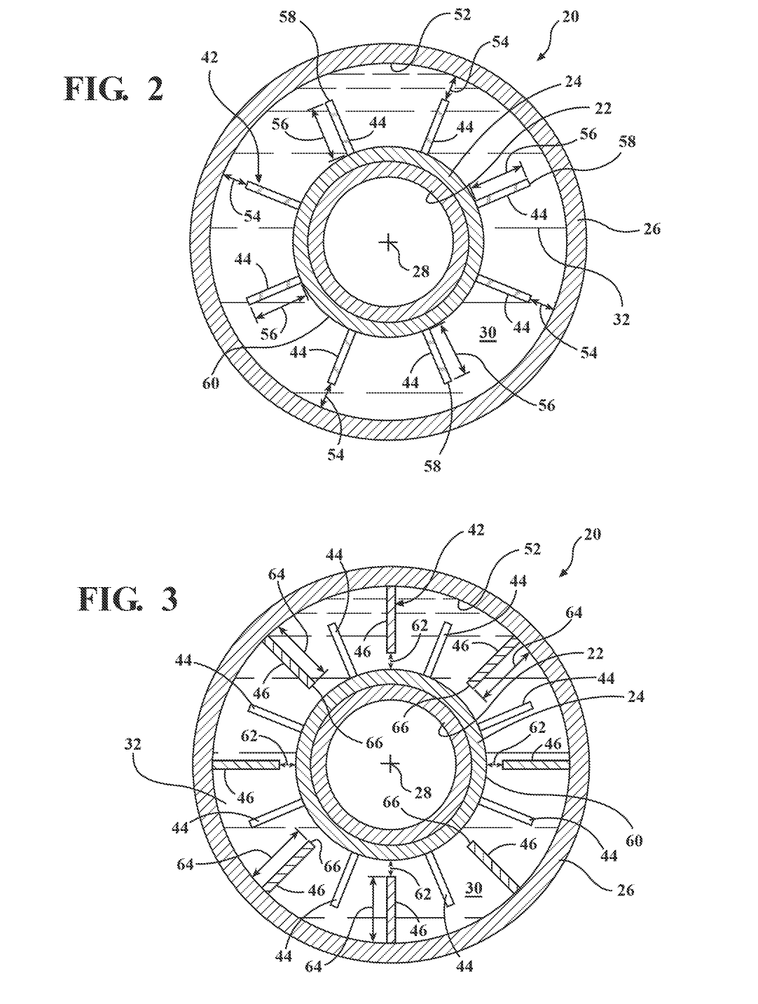

As best shown in FIGS. 2 through 4, a damping fluid 32 is disposed in the interior region 30, between the inner sleeve 24 and the outer sleeve 26. The damping fluid 32 may include a viscosity between the range of 50 cSt and 1,000 cSt. Preferably, the damping fluid 32 may include silicone. However, it should be appreciated that the damping fluid 32 may include a fluid other than silicone, which is not listed herein.

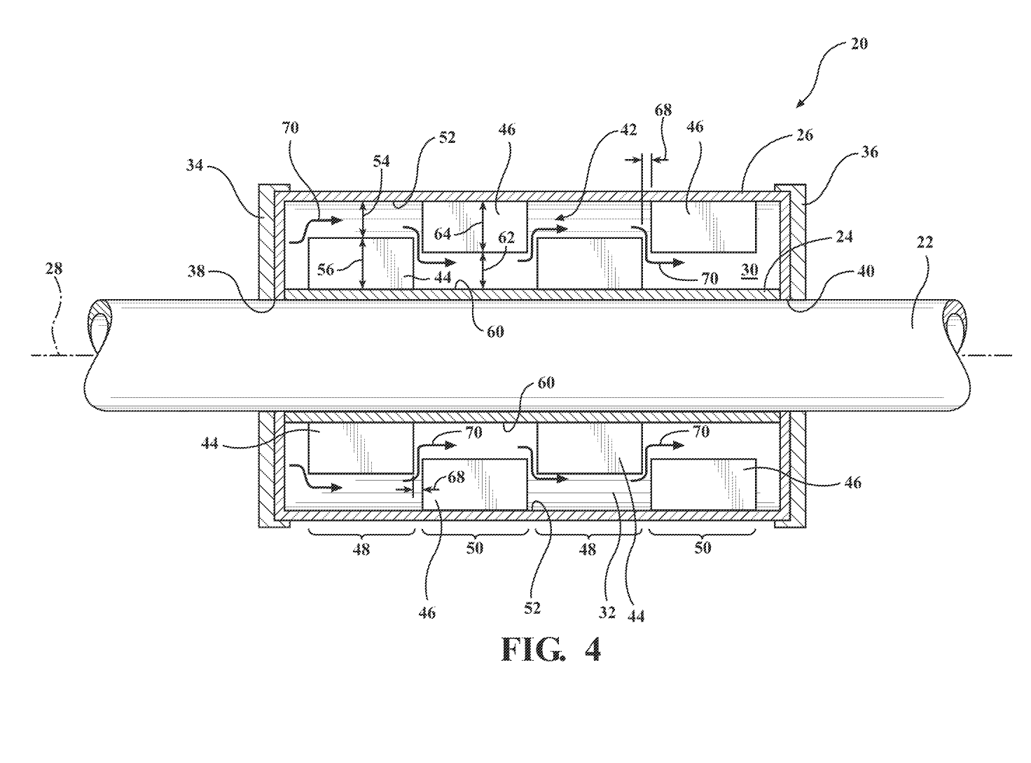

Referring to FIG. 4, the damping assembly includes a first end cap 34 and a second end cap 36. The first end cap 34 is disposed at a first axial end 38 of the inner sleeve 24 and the outer sleeve 26. The second end cap 36 is disposed at a second axial end 40 of the inner sleeve 24 and the outer sleeve 26. Accordingly, the first end cap 34 and the second end cap 36 are disposed at opposing axial ends of the inner sleeve 24 and the outer sleeve 26, along the longitudinal axis 28. The first end cap 34 and the second end cap 36 support the inner sleeve 24 and the outer sleeve 26 in spaced relationship therebetween. The first end cap 34 and the second end cap 36 are coupled to each of the inner sleeve 24 and the outer sleeve 26 to rotatably support the inner sleeve 24 relative to the outer sleeve 26. Accordingly, the first end cap 34 and the second end cap 36 may include a bearing and/or a race for rotatably supporting one or both of the inner sleeve 24 and/or the outer sleeve 26, so that the inner sleeve 24 and the outer sleeve 26 are freely rotatable relative to each other about the longitudinal axis 28. The first end cap 34 and the second end cap 36 are operable to seal the damping fluid 32 between the inner sleeve 24 and the outer sleeve 26, within the interior region 30 defined therebetween. Accordingly, the first end cap 34 and the second end cap 36 may include one or more seals for engaging the inner sleeve 24 and the outer sleeve 26, to prevent the damping fluid 32 from leaking out of the interior region 30.

At least one of the inner sleeve 24 and the outer sleeve 26 includes a damping feature 42 for engaging and interacting with the damping fluid 32. The engagement between the damping feature 42 and the damping fluid 32 resists rotation of the inner sleeve 24 relative to the outer sleeve 26 to attenuate torsional vibration disturbances transmitted to the inner sleeve 24. The damping feature 42 may include, but is not limited to, any surface design feature incorporated into an outer surface 60 of the inner sleeve 24, or an inner surface 52 of the outer sleeve 26, such as but not limited to keyways, channels, veins, fins, paddles, etc.

For example, and as shown in the Figures, the damping feature 42 may include at least one inner fin 44 attached to the inner sleeve 24, and at least one outer fin 46 attached to the outer sleeve 26. As shown in the Figures, the at least one inner fin 44 includes a plurality of fins, and the at least one outer fin 46 includes a plurality of fins. As shown in FIGS. 1 and 4, the plurality of inner fins 44 are arranged to define a plurality of annular rows 48 of inner fins 44. Each of the rows of inner fins 44 is disposed annularly about the longitudinal axis 28. The plurality of outer fins 46 are arranged to define a plurality of annular rows 50 of outer fins 46. Each of the rows of the outer fins 46 is disposed annularly about the longitudinal axis 28. The annular rows 48 of inner fins 44 and the annular rows 50 of outer fins 46 are arranged in an alternating relationship along the longitudinal axis 28. Accordingly, each annular row of inner fins 44 is adjacent to at least one annular row of outer fins 46, and each annular row of outer fins 46 is adjacent to at least one annular row of inner fins 44.

Referring to FIG. 2, the inner fins 44 extend radially outward from the inner sleeve 24, relative to the longitudinal axis 28. Each of the inner fins 44 and the inner surface 52 of the outer sleeve 26 define an inner radial separation distance 54 therebetween. Preferably, the inner radial separation distance 54 is between the range of 0.5 mm and 5 mm. More preferably, the inner radial separation distance 54 is approximately equal to 1.0 mm. The inner fins 44 include an inner radial length 56 measured radially relative to the longitudinal axis 28. The inner radial length 56 is measured from the inner sleeve 24, radially outward to a distal edge 58 of the inner fins 44. Preferably, the inner radial length 56 of the inner fins 44 is between the range of 15 mm and 35 mm. More preferably, the inner radial length 56 of the inner fins 44 is approximately equal to 25 mm.

Referring to FIG. 3, the outer fins 46 extend radially inward from the outer sleeve 26, relative to the longitudinal axis 28. Each of the outer fins 46 and the outer surface 60 of the inner sleeve 24 define an outer radial separation distance 62 therebetween. Preferably, the outer radial separation distance 62 is between the range of 0.5 mm and 5 mm. More preferably, the outer radial separation distance 62 is approximately equal to 1.0 mm. The outer fins 46 include an outer radial length 64 measured radially relative to the longitudinal axis 28. The outer radial length 64 is measured from the outer sleeve 26, radially inward to a distal edge 66 of the outer fins 46. Preferably, the outer radial length 64 of the outer fins 46 is between the range of 15 mm and 35 mm. More preferably, the outer radial length 64 of the outer fins 46 is approximately equal to 25 mm.

Referring to FIG. 4, the inner fins 44 and the outer fins 46 are axially spaced from each other along the longitudinal axis 28. As such, the inner fins 44 and the outer fins 46 define an axial separation distance 68 therebetween. The axial separation distance 68 is measured along the longitudinal axis 28, and is the distance between and separating axially adjacent pairs of inner fins 44 and outer fins 46. Preferably, the axial separation distance 68 is between the range of 0.5 mm and 5.0 mm. More preferably, the axial separation distance 68 is approximately equal to 1.0 mm. Additionally, and as shown, the inner fins 44 and the outer fins 46 radially overlap each other relative to the longitudinal axis 28. Accordingly, the distal edges 58 of the inner fins 44 extend radially outward beyond the distal edges 66 of the outer fins 46, and the distal edges 66 of the outer fins 46 extend radially inward beyond the distal edges 58 of the inner fins 44.

As noted above, the inner sleeve 24 rotates with the rotating shaft 22 about the longitudinal axis 28. The inner sleeve 24 is also able to rotate relative to the outer sleeve 26. As the inner sleeve 24 rotates, the plurality of inner fins 44 engages the damping fluid 32, causing the damping fluid 32 to move within the interior region 30 defined between the inner sleeve 24 and the outer sleeve 26. Movement of the damping fluid 32, which is also engaged with the outer fins 46, causes the outer sleeve 26 to rotate. It should be appreciated that the outer sleeve 26 may not rotate at the same speed as the inner sleeve 24, i.e., the outer sleeve 26 and the inner sleeve 24 may rotate relative to the other. The relative rotational difference between the outer sleeve 26 and the inner sleeve 24 causes the damping fluid 32 to move around and between the outer fins 46 and the inner fins 44. Referring to FIGS. 2 through 4, the movement of the damping fluid 32 is generally indicated by movement arrows 70. The rotational movement of the inner sleeve 24 and the outer sleeve 26, and the interaction between the inner fins 44 and the damping fluid 32 and the outer fins 46 and the damping fluid 32, absorb energy from the rotating shaft 22, which dampens torsional vibration in the rotating shaft 22.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A damper assembly for a rotating shaft, the damper assembly comprising:
an inner sleeve extending along a longitudinal axis;
an outer sleeve extending along the longitudinal axis and disposed radially outward of the inner sleeve relative to the longitudinal axis, wherein the inner sleeve is rotatable relative to the outer sleeve about the longitudinal axis; and
a damping fluid disposed between the inner sleeve and the outer sleeve;
wherein at least one of the inner sleeve and the outer sleeve includes a damping feature engaging the damping fluid, wherein the engagement between the damping feature and the damping fluid resists rotation of the inner sleeve relative to the outer sleeve to attenuate torsional vibration disturbances transmitted to the inner sleeve.

2. The damper assembly as set forth in claim 1 wherein the damping feature includes at least one inner fin attached to the inner sleeve, and extending radially outward from the inner sleeve, relative to the longitudinal axis.

3. The damper assembly as set forth in claim 2 wherein the damping feature includes at least one outer fin attached to the outer sleeve, and extending radially inward from the outer sleeve, relative to the longitudinal axis.

4. The damper assembly as set forth in claim 3 wherein the at least one inner fin and the at least one outer fin are axially spaced from each other along the longitudinal axis.

5. The damper assembly as set forth in claim 4 wherein the at least one inner fin and the at least one outer fin radially overlap each other relative to the longitudinal axis.

6. The damper assembly as set forth in claim 5 wherein the at least one inner fin includes an inner radial length relative to the longitudinal axis between 15 mm and 35 mm, and wherein the at least one outer fin includes an outer radial length relative to the longitudinal axis between 15 mm and 35 mm.

7. The damper assembly as set forth in claim 5 wherein the at least one inner fin and the at least one outer fin define an axial separation distance therebetween, measured along the longitudinal axis, wherein the axial separation distance is between 0.5 mm and 5.0 mm.

8. The damper assembly as set forth in claim 3 wherein each of the at least one inner fin and the outer sleeve define an inner radial separation distance therebetween, wherein the inner radial separation distance is between 0.5 mm and 5 mm.

9. The damper assembly as set forth in claim 3 wherein each of the at least one outer fin and the inner sleeve define an outer radial separation distance therebetween, wherein the outer radial separation distance is between 0.5 mm and 5 mm.

10. The damper assembly as set forth in claim 3 wherein the at least one inner fin includes a plurality of inner fins arranged to define a plurality of annular rows of inner fins disposed annularly about the longitudinal axis, and wherein the at least one outer fin includes a plurality of outer fins arranged to define a plurality of annular rows of outer fins disposed annularly about the longitudinal axis.

11. The damper assembly as set forth in claim 10 wherein the annular rows of inner fins and the annular rows of outer fins are arranged in an alternating relationship along the longitudinal axis.

12. The damper assembly as set forth in claim 1 wherein the damping fluid includes a viscosity between 50 cSt and 1,000 cSt.

13. The damper assembly as set forth in claim 1 wherein the damping fluid is silicone.

14. The damper assembly as set forth in claim 1 wherein the inner sleeve includes and is manufactured from a metal, and wherein the outer sleeve includes and is manufactured from a metal.

15. The damper assembly as set forth in claim 1 further comprising a first end cap disposed at a first axial end of the inner sleeve and the outer sleeve, and a second end cap disposed at a second axial end of the inner sleeve and the outer sleeve, wherein the first end cap and the second end cap are coupled to each of the inner sleeve and the outer sleeve to rotatably support the inner sleeve relative to the outer sleeve in spaced relationship therebetween, and to seal the damping fluid between the inner sleeve and the outer sleeve.

16. A fluid damper comprising:
an inner sleeve extending along a longitudinal axis, and configured for attachment to and rotation with a rotating shaft;
at least one inner fin attached to the inner sleeve, and extending radially outward from the inner sleeve, relative to the longitudinal axis;
an outer sleeve extending along the longitudinal axis and disposed radially outward of the inner sleeve relative to the longitudinal axis, wherein the inner sleeve is rotatable relative to the outer sleeve about the longitudinal axis;
at least one outer fin attached to the outer sleeve, and extending radially inward from the outer sleeve, relative to the longitudinal axis; and
a damping fluid disposed between the inner sleeve and the outer sleeve;
wherein the at least one inner fin and the at least one outer fin each engage the damping fluid to resist rotation of the inner sleeve relative to the outer sleeve and to attenuate torsional vibration disturbances transmitted to the inner sleeve from the rotating shaft.

17. The fluid damper as set forth in claim 16 wherein the at least one inner fin and the at least one outer fin are axially spaced from each other, along the longitudinal axis, to define an axial separation distance therebetween, wherein the axial separation distance is between 0.5 mm and 5.0 mm.

18. The fluid damper as set forth in claim 16 wherein the at least one inner fin and the at least one outer fin radially overlap each other relative to the longitudinal axis.

19. The fluid damper as set forth in claim 16 wherein the damping fluid is silicone.

20. The fluid damper as set forth in claim 16 further comprising a first end cap disposed at a first axial end of the inner sleeve and the outer sleeve, and a second end cap disposed at a second axial end of the inner sleeve and the outer sleeve, wherein the first end cap and the second end cap are coupled to each of the inner sleeve and the outer sleeve to rotatably support the inner sleeve relative to the outer sleeve in spaced relationship therebetween, and to seal the damping fluid between the inner sleeve and the outer sleeve.
